(19) United States
(12) Patent Application Publication
(10) Pub. No.: US 2018/0047030 A1
(43) Pub. Date: Feb. 15, 2018

(54) CUSTOMER SERVICE DEVICE, CUSTOMER SERVICE METHOD, AND CUSTOMER SERVICE SYSTEM

(71) Applicant: Panasonic Intellectual Property Management Co., Ltd., Osaka (JP)

(72) Inventors: ATSUSHI SASO, Kanagawa (JP); NAOMI TOMIYAMA, Kyoto (JP); YUICHI AOKI, Osaka (JP); MOTOJI OHMORI, Osaka (JP)

(21) Appl. No.: 15/659,054

(22) Filed: Jul. 25, 2017

(30) Foreign Application Priority Data
Aug. 10, 2016 (JP) 2016-157465

(51) Int. Cl. G06Q 30/00

(52) U.S. Cl. CPC G06Q 30/016

(57) ABSTRACT

A customer service device, comprising: an estimator that estimates an emotion of a customer by analyzing biological data of the customer; a handover reviewer that determines whether or not a response to the customer is to be handed over to a customer service successor, based on the emotion estimated by the estimator; a handover information generator that, when the handover reviewer has determined that the response to the customer is to be handed over to the customer service successor, generates handover information including first response content carried out to the customer and handover content that is based on the first response content; and a communicator that transmits the handover information generated by the handover information generator.

### BACKGROUND

### 1. Technical Field

The present disclosure relates to a customer service device that provides customer service to a customer and hands over a customer service result to a customer service successor, a customer service method for the customer service device, and a customer service system that provides customer service to a customer and hands over a customer service result to a customer service successor. The present disclosure relates to a technology with which a robot provides customer service to a customer in a hotel, a store, or the like and hands over a customer service result to a customer service successor.

### 2. Description of the Related Art

In recent years, owing to the development of artificial intelligence, various customer service tasks such as reception tasks and guiding tasks have come to be carried out using robots rather than humans. These tasks are carried out in retail stores, banks, hotels, medical facilities, nursing homes, schools, manufacturing plants, and various other facilities.

The following is disclosed in Japanese Unexamined Patent Application Publication No. 2009-131914, for example. First, a robot transmits operation history information regarding communication actions, to a central control unit. The central control unit constructs an individual behavior transition database (DB), an age/gender-dependent behavior transition DB, and a location-dependent behavior transition DB on the basis of remote operations among the operation history information from the robot. The robot selects a DB corresponding to the name, age/gender, or location of a dialogue partner. The robot refers to the selected DB and determines the next communication action on the basis of operation history information that matches a command indicating the present robot operation and an action of the dialogue partner carried out with respect to said robot operation. In Japanese Unexamined Patent Application Publication No. 2009-131914, the robot performs autonomous actions on the basis of operation history information regarding remote operations, and it is therefore supposedly possible for the number of remote operations performed by an operator to be reduced as much as possible.

Furthermore, the following is disclosed in Japanese Unexamined Patent Application Publication No. 2007-190641, for example. A communication robot includes numerous sensors for detecting the surroundings and the state of the communication robot, and determines whether or not an operator call condition has been satisfied on the basis of sensor output. The communication robot carries out communication actions or the like with humans to provide services such as reception and guidance services, normally by means of autonomous control. When having determined that the operator call condition has been satisfied, the communication robot transmits a call request to an operator terminal via a network. The operator operates the operator terminal and transmits a control command to the communication robot in accordance with the call request. The communication robot executes a communication action in accordance with the control command. In Japanese Unexamined Patent Application Publication No. 2007-190641, it is supposedly possible for appropriate services to be provided in an efficient manner.

### SUMMARY

One non-limiting and exemplary embodiment provides a customer service device, a customer service method, and a customer service system with which a customer service result of the customer service device with respect to a customer can be smoothly handed over from the customer service device to a customer service successor.

In one general aspect, the techniques disclosed here feature a customer service device, comprising: an estimator that estimates an emotion of a customer by analyzing biological data of the customer, a handover reviewer that determines whether or not a response to the customer is to be handed over to a customer service successor, based on the emotion estimated by the estimator; a handover information generator that, when the handover reviewer has determined that the response to the customer is to be handed over to the customer service successor, generates handover information including first response content carried out to the customer and handover content that is based on the first response content; and a communicator that transmits the handover information generated by the handover information generator.

General or specific aspects may be realized by an element, a device, an apparatus, a system, an integrated circuit, or a method. Furthermore, general or specific aspects may be realized by an arbitrary combination of an element, a device, an apparatus, a system, an integrated circuit, and a method.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram depicting an example of a configuration of a customer service system according to an embodiment of the present disclosure;

FIG. 2 is a drawing depicting an example of action rules stored in an action rule storage unit of a robot depicted in FIG. 1;

FIG. 3 is a sequence diagram depicting an example of customer service processing performed by the customer service system depicted in FIG. 1;

FIG. 4 is a flowchart depicting an example of customer service handover processing performed by the robot depicted in FIG. 1;

FIG. 5 is a drawing depicting an example of history information of a customer stored in a handover-related information storage unit of a server depicted in FIG. 1;

FIG. 6 is a drawing depicting an example of an emergency handover screen depicting handover information including response support request information displayed on a tablet depicted in FIG. 1; and

FIG. 7 is a drawing depicting an example of a normal handover screen depicting handover information not including the response support request information displayed on the tablet depicted in FIG. 1.

### DETAILED DESCRIPTION

### Findings Forming the Basis for the Present Disclosure

The ability of robots to communicate with humans is improving daily, and it is envisaged that from hereon there will be an increase in cases where robots take the place of humans and carry out communication such as customer service for customers (humans). However, robots do not have the communication ability to completely understand the emotions of humans and conclude complete customer service responses, and it is difficult for robots to take over customer service entirely. Thus, there are many cases where the final stage of customer service has to be carried out by a human (customer service successor).

However, in the aforementioned prior art, no investigation whatsoever was carried out into the handover of customer service content from a customer service device such as a communication robot to a customer service successor, and it was difficult for a customer service result for a customer to be smoothly handed over from the customer service device to the customer service successor.

In this regard, a robot is capable of measuring an emotion (for example, stress) of a customer with whom the robot is interacting, and is capable of responding, to an extent, to the customer in accordance with the measured emotion of the customer. Consequently, when the robot hands over a customer service task to a customer service successor, the type of emotion of the customer is handed over to the customer service successor, and the customer service successor is thereby able to provide better customer service.

Cases are envisaged where, for example, the robot no longer knows how best to respond in situations mainly such as when not understanding the content being asked by the customer or not being able to grasp the intention of the customer. In such cases, when the content of a response to the customer is to be handed over to the customer service successor by the robot, the robot senses the emotion and state of the customer, and hands over a customer service response including a proposal such as to respond by talking slightly quickly for customers who are in a hurry. The customer service successor is thereby able to provide better customer service.

Furthermore, cases are envisaged where responses are made to trouble with copy machines in convenience stores. In such cases, first, a robot responds. Next, when handing over from the robot to the customer service successor, information such as “the robot has caused trouble in this kind of situation” is presented to the customer service successor, and the timing and situation in which a store visitor has become irritated is passed on to the customer service successor. The robot is thereby able to smoothly hand over the customer service response to the customer service successor.

Furthermore, in the case where the robot has recognized that the customer is feeling hesitant or indecisive, “this customer is still uncertain” is passed on or “there is room for another proposal if a human (customer service successor) responds” is passed on as handover information, for example. It is thereby possible for the customer service response to be smoothly handed over to the customer service successor.

Based on the aforementioned findings, the inventors of the present application carried out a diligent investigation into how a customer service response should be handed over from a robot (customer service device) to a human (customer service successor). As a result, the present disclosure was completed.

An overview of an aspect of the present disclosure is as follows. The customer service device of the present disclosure can be realized by means of a robot that is provided with some of the constituent elements, and a server that is provided with the other constituent elements and is communicably connected to the robot. Furthermore, the customer service device of the present disclosure may be realized by means of a robot or a server provided with all of the constituent elements.

### [Item 1]

A customer service device, comprising: an estimator that estimates an emotion of a customer by analyzing biological data of the customer; a handover reviewer that determines whether or not a response to the customer is to be handed over to a customer service successor, based on the emotion estimated by the estimator; a handover information generator that, when the handover reviewer has determined that the response to the customer is to be handed over to the customer service successor, generates handover information including first response content carried out to the customer and handover content that is based on the first response content; and a communicator that transmits the handover information generated by the handover information generator.

According to item 1, biological data of the customer is acquired, an emotion of the customer is estimated by analyzing the acquired biological data, and whether or not a response to the customer is to be handed over to a customer service successor is determined on the basis of the estimated emotion. At such time, in the case where it is determined that the response to the customer is to be handed over to the customer service successor, handover information including response content carried out by the customer service device with respect to the customer and handover content that is based on the response content is generated, and the generated handover information is transmitted to a communication terminal possessed by the customer service successor, for example. As a result, the customer service successor is able to confirm, using the communication terminal, the response content carried out by the customer service device with respect to the customer and the handover content that is based on the response content, and a customer service result of the customer service device with respect to the customer can be smoothly handed over from the customer service device to the customer service successor.

### [Item 2]

The customer service device according to item 1, further comprising: a biological data detector that acquires the biological data of the customer.

### [Item 3]

The customer service device according to item 1, wherein when the handover reviewer has determined that the response to the customer is to be handed over to the customer service successor, the handover information generator generates the handover information including response support request information indicating that support by the customer service successor is necessary.

According to the configuration of item 3, in the case where it is determined that the response to the customer is to be handed over to the customer service successor, handover information including response support request information indicating that support from the customer service successor is necessary is generated. Therefore, in the case where the customer service device is not able to smoothly carry out a response to the customer, the necessity for support from the customer service successor can be presented on the communication terminal, for example, and the response to the customer can be urgently handed over from the customer service device to the customer service successor.

### [Item 4]

The customer service device according to any one of items 1 to 3, further comprising: a first storage that stores, in advance, second response content to be carried out to the customer, in association with the emotion of the customer, wherein the handover reviewer refers to the first storage and, when the second response content associated with the emotion estimated by the estimator is a response support request for the customer service successor, determines that the response to the customer is to be handed over to the customer service successor.

According to the configuration of item 4, appropriate response content can be determined with respect to an estimated emotion by referring to a first storage that associates and stores, in advance, emotions of the customer and response content to be executed by the customer service device, and in the case where the determined response content is a response support request for the customer service successor, it is determined that the response to the customer is to be handed over to the customer service successor. Therefore, cases where the customer service device is not able to smoothly respond to the customer can be accurately determined, and in cases where it is necessary for the customer service successor to respond to the customer, a handover can be urgently performed from the customer service device to the customer service successor.

### [Item 5]

The customer service device according to item 4, wherein the estimator estimates a plurality of levels indicating degree of anger of the customer by analyzing the biological data, the first storage stores, in advance, the second response content to be carried out to the customer, in association with each of the plurality of levels, and the handover reviewer refers to the first storage and, when a level estimated by the estimator is equal to or greater than a predetermined level, determines that the response to the customer is to be handed over to the customer service successor.

According to the configuration of item 5, an anger emotion felt by the customer is classified into a plurality of levels, and in the case where the level of the estimated anger emotion is equal to or greater than a predetermined level, it is determined that the response to the customer is to be handed over to the customer service successor. Therefore, cases where the customer service device is not able to smoothly respond to the customer can be accurately determined, and a handover can be urgently performed from the customer service device to the customer service successor only in cases where it is necessary for the customer service successor to respond to the customer.

### [Item 6]

The customer service device according to item 5, further comprising: an attribute acquirer that acquires an attribute of the customer, wherein the handover reviewer, when the attribute of the customer acquired by the attribute acquirer does not correspond to a predetermined important condition and an anger emotion estimated by the estimator is equal to or greater than a first level, determines that the response to the customer is to be handed over to the customer service successor, and when the attribute of the customer acquired by the attribute acquirer corresponds to the predetermined important condition and the anger emotion estimated by the estimator is equal to or greater than a second level that is lower than the first level, determines that the response to the customer is to be handed over to the customer service successor.

According to the configuration of item 6, when an attribute of the customer does not correspond to a predetermined important condition, in the case where an estimated anger emotion is equal to or greater than a first level, it is determined that the response to the customer is to be handed over to the customer service successor, and, when the attribute of the customer corresponds to the predetermined important condition, in the case where the estimated anger emotion is equal to or greater than a second level that is lower than the first level, it is determined that the response to the customer is to be handed over to the customer service successor. Therefore, it is possible to change the level of the anger emotion in the case where the response to the customer is to be handed over to the customer service successor, in accordance with the attribute of the customer. Consequently, the ratio of customer service performed by the customer service successor can be increased with respect to important customers, the ratio of customer service performed by the customer service device can be increased with respect to normal customers, and the customer service device can be utilized effectively while increasing the level of satisfaction of customer service for important customers.

### [Item 7]

The customer service device according to any one of items 1 to 6, further comprising: an identification information acquirer that acquires identification information identifying the customer; a second storage that stores history information indicating past customer service history for the customer, in association with the identification information; and a response determiner that acquires the history information of the customer corresponding to the identification information acquired by the identification information acquirer from the second storage, and determines the response to the customer, based on the history information.

According to the configuration of item 7, past customer service history is stored for each customer, a response to a customer is determined on the basis of the past customer service history, and therefore an appropriate response corresponding to the customer can be carried out.

### [Item 8]

The customer service device according to item 7, wherein when the handover reviewer has determined that the response to the customer is not to be handed over to the customer service successor, the handover information generator generates the handover information including the first response content carried out to the customer and the handover content that is based on the first response content, and the second storage stores the handover information generated by the handover information generator, as the history information.

According to the configuration of item 8, handover information including response content carried out by the customer service device with respect to the customer and handover content that is based on the response content is sequentially accumulated as history information in a second storage. Therefore, a response to the customer can be appropriately determined on the basis of the past customer service history accumulated, and a more appropriate response corresponding to the customer can be carried out.

### [Item 9]

The customer service device according to any one of items 1 to 8, wherein the handover information generator generates the handover information including emotion information indicating the emotion estimated by the estimator.

According to the configuration of item 9, the emotion of the customer can also be presented to the customer service successor in addition to response content carried out by the customer service device with respect to the customer and handover content that is based on the response content. Therefore, the customer service successor can provide a more appropriate response by taking the emotion of the customer also into consideration.

### [Item 10]

The customer service device according to any one of items 1 to 9, further comprising a reply outputter that includes at least one of a speaker, a display, and a human-shaped body, and provides customer service to the customer by using at least one of speech, video, and movement.

According to the configuration of item 10, the robot can provide appropriate customer service using at least one of speech, video, and body movement.

Furthermore, the present disclosure can not only be realized as a customer service device provided with characteristic configurations such as the aforementioned but can also be realized as a customer service method or the like for executing characteristic processing corresponding to the characteristic configurations provided in the customer service device. Furthermore, in addition to the customer service device of the present disclosure, the present disclosure may be configured as a customer service system provided with a communication terminal possessed by the customer service successor. Consequently, an effect similar to that of the aforementioned customer service device can be demonstrated also in other aspects described hereinafter.

### [Item 11]

A customer service method, including: acquiring biological data of a customer; estimating an emotion of the customer by analyzing the biological data; determining whether or not a response to the customer is to be handed over to a customer service successor, based on the emotion; when it is determined that the response to the customer is to be handed over to the customer service successor, generating handover information including response content carried out to the customer and handover content that is based on the response content; and transmitting the handover information.

### [Item 12]

A customer service system, comprising: a robot that provides customer service to a customer; a server that communicates with the robot; and a communication terminal that communicates with the server, wherein the robot comprises: an estimator that estimates an emotion of the customer by analyzing biological data of the customer; and a handover reviewer that determines whether or not a response to the customer is to be handed over to a customer service successor, based on the emotion estimated by the estimator, the server comprises: a handover information generator that, when the handover reviewer has determined that the response to the customer is to be handed over to the customer service successor, generates handover information including response content carried out to the customer and handover content that is based on the response content; and a communicator that transmits the handover information generated by the handover information generator to the communication terminal, and the communication terminal comprises a handover information presenter that presents the handover information.

Furthermore, it is possible for the present disclosure to be realized as a computer program that causes a computer to execute the characteristic processing included in the aforementioned customer service method. Also, it goes without saying that such a computer program can be distributed by way of a computer-readable non-transitory recording medium such as a CD-ROM or a communication network such as the Internet.

It should be noted that the embodiments described hereinafter all represent a specific example of the present disclosure. The numerical values, the shapes, the constituent elements, the steps, the order of the steps, and the like given in the following embodiments are examples and are not intended to restrict the present disclosure. Furthermore, from among the constituent elements in the following embodiments, constituent elements that are not mentioned in the independent claims indicating the most significant concepts are described as optional constituent elements. Furthermore, in all of the embodiments, it is also possible to combine the respective content thereof.

### Embodiments

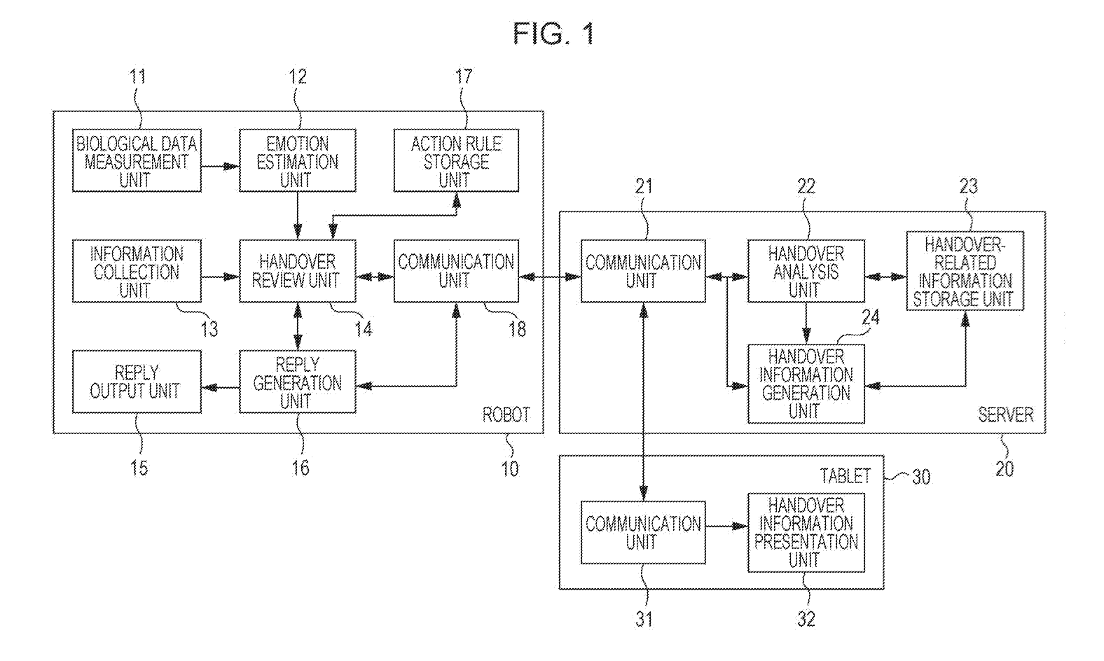

Hereinafter, embodiments of the present disclosure will be described with reference to the drawings. FIG. 1 is a block diagram depicting an example of a configuration of a customer service system according to an embodiment of the present disclosure. The customer service system depicted in FIG. 1 is provided with a robot 10, a server 20, and a tablet 30.

The robot 10 is a humanoid robot that provides customer service to a customer using at least one of speech, video, and body movement. Here, the customer is normally a human. The robot 10 is normally a machine. The server 20 is communicably connected to the robot 10 via a wired or wireless communication line (not depicted). The tablet 30 is an example of a communication terminal possessed, carried, or used by a customer service successor. The tablet 30 is communicably connected to the server 20 via a wired or wireless communication line (not depicted).

The robot 10 is provided with a biological data measurement unit 11, an emotion estimation unit 12, an information collection unit 13, a handover review unit 14, a reply output unit 15, a reply generation unit 16, an action rule storage unit 17, and a communication unit 18. The server 20 is provided with a communication unit 21, a handover analysis unit 22, a handover-related information storage unit 23, and a handover information generation unit 24. The tablet 30 is provided with a communication unit 31 and a handover information presentation unit 32.

Here, the biological data measurement unit 11 corresponds to an example of the biological data detector. The emotion estimation unit 12 corresponds to an example of the estimator. The handover review unit 14 corresponds to an example of the handover reviewer. The handover information generation unit 24 corresponds to an example of the handover information generator. The communication unit 21 corresponds to an example of the communicator. The action rule storage unit 17 corresponds to an example of the first storage. The information collection unit 13 corresponds to an example of the attribute acquirer or the identification information acquirer. The handover-related information storage unit 23 corresponds to an example of the second storage. The reply generation unit 16 corresponds to an example of the response determiner. The handover information presentation unit 32 corresponds to an example of the handover information presenter.

The communication unit 18 of the robot 10 communicates between the robot 10 and the server 20. The communication unit 18 transmits various information generated by the robot 10 to the communication unit 21, and receives various information generated by the server 20 from the communication unit 21.

The biological data measurement unit 11 acquires biological data of the customer. For example, the biological data measurement unit 11 is provided with a sensor that measures human pulse waves in a non-contact manner using a highly sensitive spread-spectrum millimeter-wave radar or the like, and detects the heart rate and heart rate fluctuations of the customer.

It should be noted that the configuration of the biological data measurement unit 11 is not particularly restricted to this example. For example, a smartwatch that measures vital data or the like of a human may be attached to the customer, and the vital data or the like may be acquired from the smartwatch.

Furthermore, the biological data acquired by the biological data measurement unit 11 is also not particularly restricted to the aforementioned pulse waves. For biological data with which it is possible to estimate an emotion, for example, speech, facial images, blood oxygen concentration, blood pressure, and body temperature may be used. In this case, the biological data measurement unit 11 is configured in such a way as to measure each item of biological data.

The emotion estimation unit 12 estimates an emotion of the customer by analyzing the biological data acquired by the biological data measurement unit 11 (for example, see the specification of Japanese Patent No. 5257525).

Specifically, the emotion estimation unit 12 sets four threshold values, first to fourth threshold values Th1a to Th4a (Th1a<Th2a<Th3a<Th4a), with respect to the heart rate acquired by the biological data measurement unit 11. In the case where the heart rate is greater than the third threshold value Th3a and equal to or less than the fourth threshold value Th4a, and heart rate fluctuations are within a predetermined reference range R1a to R2a, it is estimated that the emotion of the customer is “anger” of a “high” level. In the case where the heart rate is greater than the second threshold value Th2a and equal to or less than the third threshold value Th3a, and heart rate fluctuations are within the reference range R1a to R2a, it is estimated that the emotion of the customer is “anger” of an “intermediate” level. In the case where the heart rate is greater than the first threshold value Th1a and equal to or less than the second threshold value Th2a, and heart rate fluctuations are within the reference range R1a to R2a, it is estimated that the emotion of the customer is “anger” of a “low” level.

Furthermore, the emotion estimation unit 12 sets the first to fourth threshold values Th1a to Th4a and a predetermined reference range R1b to R2b (R1b>R2a) with respect to “happiness”, sets predetermined first to fourth threshold values Th1b to Th4b (Th1b<Th2b<Th3b<Th4b<Th1a) and the reference range R1a to R2b with respect to “sadness”, and sets the first to fourth threshold values Th1b to Th4b and the reference range R1b to R2b with respect to “enjoyment”. In addition, by determining conditions similar to the aforementioned, the emotion estimation unit 12 may estimate which of the three levels of “high”, “intermediate”, and “low” is applicable for the emotion of the customer with respect to each of “happiness”, “sadness”, and “enjoyment”.

It should be noted that the method for estimating the emotion of the customer using biological data is not particularly restricted to the aforementioned example. For example, various alterations are possible such as specifying the emotion of the customer using the degree of wakefulness or degree of comfort of the customer generated from biological sensor values (for example, see the specification of Japanese Patent No. 5735592).

The information collection unit 13 collects query information indicating query content from the customer. In addition, the information collection unit 13 acquires attributes and a user ID of the customer. Here, the user ID is an example of the identification information.

Specifically, the information collection unit 13 is provided with a microphone or the like and acquires speech of the customer. The information collection unit 13 performs speech recognition on the acquired speech, generates text data made up of character strings, and outputs the text data to the handover review unit 14.

Furthermore, the information collection unit 13 is provided with a camera or the like and captures the face of the customer. The information collection unit 13 refers to a database in which user IDs, facial images, and information indicating whether or not a customer is a premium customer are associated with each other, and acquires the user ID of the customer from a captured facial image of the customer. The information collection unit 13 acquires information indicating whether or not the customer is a premium customer, as an attribute of the customer, and outputs the acquired user ID and the information indicating whether or not the customer is a premium customer, to the handover review unit 14. Here, a premium customer means a customer who is registered as an important customer to the customer service successor.

Furthermore, the information collection unit 13 determines whether the customer is an adult or a child on the basis of the image captured by the camera, and outputs the determination result as an attribute of the customer to the handover review unit 14.

It should be noted that the attributes of the customer collected by the information collection unit 13 are not particularly restricted to the aforementioned examples. The information collection unit 13 may collect the age, gender, physique, or the like constituting features of the customer, as attributes of the customer, on the basis of an image captured by the camera.

Furthermore, the configuration of the information collection unit 13 is not particularly restricted to the aforementioned example. For example, various alterations are possible such as the customer directly inputting information and attributes using a touch panel or the like. Here, the user ID and information indicating whether or not the customer is a premium customer, for example, may serve as attributes that are input by the customer.

Furthermore, the database to which the information collection unit 13 refers may be stored in a storage unit inside the robot 10, for example, the action rule storage unit 17. Furthermore, the database may be stored in advance in the handover-related information storage unit 23 of the server 20, and reference may be made thereto via the communication unit 18 or the like. Alternatively, the database may be stored in another server or the like, and reference may be made thereto via the communication unit 18 or the like.

The action rule storage unit 17 stores, in advance, a database in which emotions of the customer and response content to be executed by the customer service device are associated with each other.

Specifically, the action rule storage unit 17 stores “happiness”, “anger”, “sadness”, and “enjoyment” as emotions of the customer. Here, “happiness” indicates that the customer is happy, “anger” indicates that the customer is angry, “sadness” indicates that the customer is sad, and “enjoyment” indicates that the customer is enjoying himself or herself. Furthermore, the action rule storage unit 17 stores response content for each emotion, for example, action content, in association with each of the aforementioned emotions as action rules. Furthermore, in the case where the emotion of the customer is “anger”, the “anger” emotion is classified into a plurality of levels, and different response content is stored in association with each level.

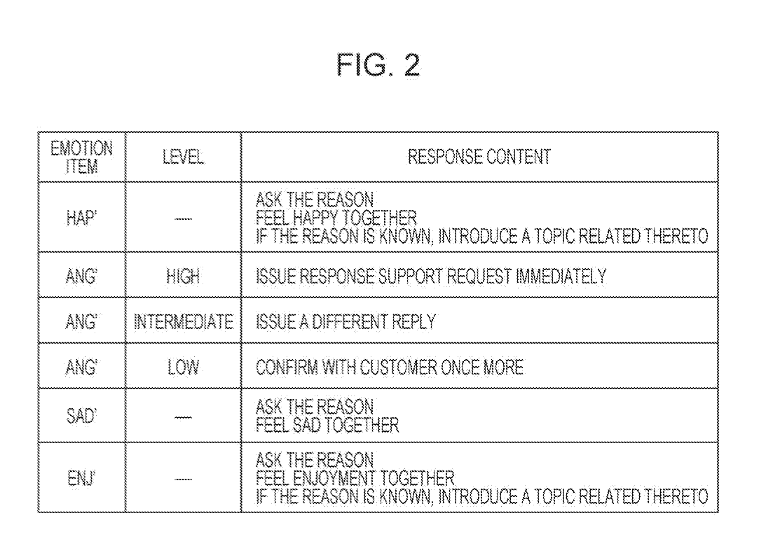

FIG. 2 is a drawing depicting an example of action rules stored in the action rule storage unit 17 of the robot depicted in FIG. 1.

As depicted in FIG. 2, the response content of “ask the reason”, “feel happy together”, and “if the reason is known, introduce a topic related thereto” are stored with respect to “happiness” (written as “Hap” in the drawing). Furthermore, the response content of “ask the reason” and “feel sad together” are stored with respect to “sadness” (written as “Sad” in the drawing). Furthermore, the response content of “ask the reason”, “feel enjoyment together”, and “if the reason is known, introduce a topic related thereto” are stored with respect to “enjoyment” (written as “Enj” in the drawing).

Furthermore, the response content of “issue response support request immediately” is stored with respect to “anger” (written as “Ang” in the drawing) of a “high” level, the response content of “issue a different reply” is stored with respect to “anger” of an “intermediate” level, and the response content of “confirm with customer once more” is stored with respect to “anger” of a “low” level.

It should be noted that the action rules stored in the action rule storage unit 17 are not particularly restricted to the aforementioned examples. For example, “happiness”, “sadness”, and “enjoyment” may also be classified into a plurality of levels and response content may be associated with each level. Alternatively, various alterations are possible such as additionally setting specific response content in accordance with the situation in which the present customer service system is being used.

Reference will once again be made to FIG. 1. The handover review unit 14 determines whether or not a response to the customer should be handed over to the customer service successor, on the basis of the emotion estimated by the emotion estimation unit 12. The handover review unit 14 outputs the determination result to the reply generation unit 16, and also notifies the determination result to the server 20 via the communication unit 18.

Specifically, the handover review unit 14 refers to the action rules stored in the action rule storage unit 17, and extracts and determines response content corresponding to the emotion estimated by the emotion estimation unit 12. In the case where the determined response content is a response support request for the customer service successor, the handover review unit 14 determines that a response to the customer is to be handed over to the customer service successor.

For example, the handover review unit 14 determines that a response to the customer is to be handed over to the customer service successor in the case where reference is made to the action rules stored in the action rule storage unit 17 and the level of the “anger” emotion estimated by the emotion estimation unit 12 is equal to or greater than a predetermined level, for example, the “high” level.

It should be noted that determination criteria of the handover review unit 14 is not restricted to only the emotion estimated by the emotion estimation unit 12. As determination criteria, various alterations are possible such as also taking into consideration exchanges with the customer collected by the information collection unit 13 or the like and the state of the customer.

Furthermore, the handover review unit 14 may alter the determination criteria according to whether or not an attribute of the customer acquired by the information collection unit 13 corresponds to a predetermined important condition. Here, the predetermined important condition may be, for example, a condition such as being a premium customer, meaning that the customer is an important customer to the customer service successor. For example, when the attribute of the customer does not correspond to the predetermined important condition, the handover review unit 14 determines that a response to the customer is to be handed over to the customer service successor in the case where the “anger” emotion estimated by the emotion estimation unit 12 is equal to or greater than a first level, for example, the “high” level. On the other hand, when the attribute of the customer does correspond to the predetermined important condition, the handover review unit 14 may determine that a response to the customer is to be handed over to the customer service successor in the case where the “anger” emotion is equal to or greater than a second level that is lower than the first level, for example, the “intermediate” level.

The reply generation unit 16 acquires, via the handover review unit 14, query information from the customer collected by the information collection unit 13. The reply generation unit 16 generates reply information for the query information from the customer on the basis of the response content or the like determined by the handover review unit 14, and outputs the reply information to the reply output unit 15.

When the aforementioned reply information is to be generated, the reply generation unit 16 issues a query to the server 20 via the communication unit 18 and acquires necessary information. Specifically, in the case where the handover review unit 14 has determined that a response to the customer is not to be handed over to the customer service successor, the reply generation unit 16 acquires, via the handover review unit 14, a user ID acquired by the information collection unit 13. The reply generation unit 16 acquires history information of the customer corresponding to the acquired user ID, as past customer service history for the customer, from the handover-related information storage unit 23, via the handover analysis unit 22 and the communication unit 18. The reply generation unit 16 refers also to this history information to generate reply information for the query information from the customer on the basis of the response content or the like determined by the handover review unit 14, and outputs the reply information to the reply output unit 15.

The reply output unit 15 outputs the reply information for the query information from the customer, the reply information generated by the reply generation unit 16. The reply output unit 15 is provided with a speaker or the like, converts the reply information generated by the reply generation unit 16 into speech, and voices the speech, for example. It should be noted that the configuration of the reply output unit 15 is not particularly restricted to the aforementioned example. For example, various alterations are possible such as converting the reply information for the query content from the customer into an image and displaying the image using a display or the like. Furthermore, in addition to a reply implemented by means of speech by the reply output unit 15, the robot 10 may perform a body movement corresponding to the reply information.

Furthermore, in the case where a response to the customer has ended, or in the case where it has been determined that the response to the customer is to be handed over to the customer service successor, the handover review unit 14 notifies response history information that includes the query information from the customer collected by the information collection unit 13 and the reply information generated by the reply generation unit 16, as response content of the robot 10, to the server 20 via the communication unit 18.

The communication unit 21 of the server 20 communicates between the server 20 and the tablet 30 in addition to communicating with the robot 10. The communication unit 21 transmits various information generated by the server 20 to the communication unit 31, and receives various information generated by the tablet 30 from the communication unit 31.

The handover analysis unit 22 analyzes the response state of the robot 10 with respect to the customer on the basis of the response history information or the like including the query information from the customer notified from the robot 10 and the reply information for the query information from the customer, via the communication unit 21.

The handover-related information storage unit 23 stores data relating to handover information to be presented to the customer service successor, in association with the user ID. The handover analysis unit 22 stores the response history information notified from the robot 10, as history information indicating past customer service history for the customer, in the handover-related information storage unit 23 in association with the user ID.

The handover information generation unit 24 generates handover information on the basis of the response state of the robot 10 with respect to the customer analyzed by the handover analysis unit 22 and on the basis of data relating to handover information stored in the handover-related information storage unit 23. Here, the data relating to handover information stored in the handover-related information storage unit 23 is history information indicating the past customer service history for the customer, for example. Furthermore, emotion information indicating the emotion estimated by the emotion estimation unit 12 may be included in the handover information generated by the handover information generation unit 24.

Specifically, in the case where the handover review unit 14 has determined that a response to the customer is not to be handed over to the customer service successor, the handover information generation unit 24 generates handover information including response content carried out with respect to the customer and handover content that is based on the response content, and causes the handover information to be stored in the handover-related information storage unit 23. In addition, the handover information generation unit 24 notifies the generated handover information to the tablet 30 via the communication unit 21.

Furthermore, in the case where the handover review unit 14 has determined that a response to the customer is to be handed over to the customer service successor, the handover information generation unit 24 generates handover information including response content carried out by the robot 10 with respect to the customer and handover content that is based on the response content, and adds response support request information indicating that support from the customer service successor is necessary, to the generated handover information. In addition, the handover information generation unit 24 causes the handover information including the response support request information to be stored in the handover-related information storage unit 23, and also notifies the handover information to the tablet 30 via the communication unit 21.

The communication unit 31 of the tablet 30 communicates between the server 20 and the tablet 30, transmits various information generated by the tablet 30 to the communication unit 21, and receives various information generated by the server 20 from the communication unit 21.

The handover information presentation unit 32 is configured from a display or the like. The handover information presentation unit 32 acquires handover information generated by the handover information generation unit 24, via the communication unit 31, and displays a handover screen created using the acquired handover information, on a display. It should be noted that the communication terminal is not particularly restricted to the tablet 30. For example, a smartphone, a notebook-type or desktop-type computer, or the like may be used as the communication terminal. Furthermore, handover speech may be created using the aforementioned handover information for a handover to be made to the customer service successor by means of speech.

Furthermore, the configuration of the present customer service system is not particularly restricted to the aforementioned example, and various alterations are possible. For example, the communication unit 18 and the server 20 may be omitted, and the handover analysis unit 22, the handover-related information storage unit 23, and the handover information generation unit 24 may be provided in the robot 10. In addition, a communication unit that transmits the handover information generated by the handover information generation unit 24 to the tablet 30 may be provided in the robot 10, and the robot 10 may also execute the processing of the server 20. In this case, the robot 10 corresponds to an example of the customer service device.

Furthermore, the emotion estimation unit 12, the handover review unit 14, the reply generation unit 16, and the action rule storage unit 17 may be omitted from the robot 10, and the emotion estimation unit 12, the handover review unit 14, the reply generation unit 16, and the action rule storage unit 17 may be provided in the server 20. At such time, the robot 10 is provided with the biological data measurement unit 11, the information collection unit 13, the reply output unit 15, and the communication unit 18. Furthermore, the communication unit 18 of the robot 10 may transmit information acquired by the biological data measurement unit 11 and the information collection unit 13 to the server 20, and also receive reply information or the like generated by the server 20. The communication unit 21 of the server 20 may receive biological data or the like acquired by the biological data measurement unit 11 of the robot 10, and the server 20 may execute the processing of the emotion estimation unit 12, the handover review unit 14, and the reply generation unit 16. In this case, the server 20 corresponds to an example of the customer service device.

Furthermore, in the case where the server 20 operates as the customer service device, a user interface device provided with the biological data measurement unit 11, the information collection unit 13, the reply output unit 15, and the communication unit 18 may be used instead of the robot 10. Such a user interface device may include a display, a speaker, and a microphone, for example.

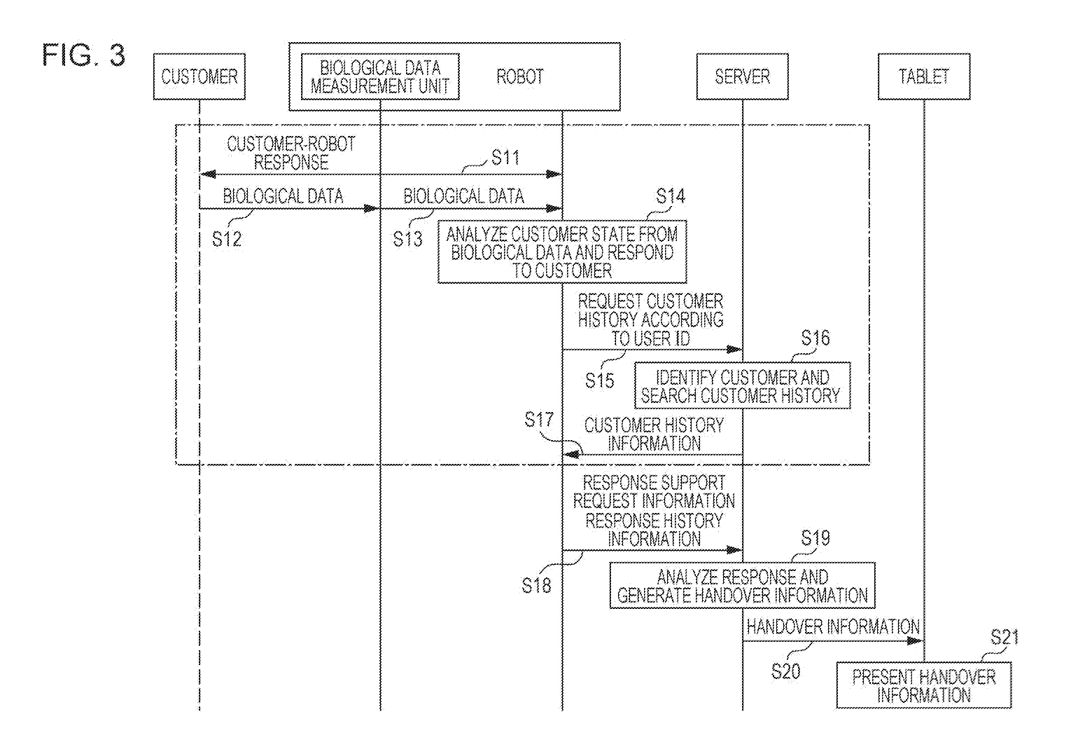

Next, a description will be given regarding customer service processing performed by the customer service system configured as mentioned above. FIG. 3 is a sequence diagram depicting an example of customer service processing performed by the customer service system depicted in FIG. 1. It should be noted that, in the description hereinafter, an example is described in which the robot 10 provides customer service to a customer in a hotel as a concierge, and a human concierge takes over from the robot 10. Here, the customer is the customer and the concierge is the customer service successor.

As depicted in FIG. 3, first, the robot 10 replies to the customer, for example, receives a question from the customer and issues a response to the question (step S11).

At such time, the biological data measurement unit 11 of the robot 10, for example, measures the pulse of the customer as biological data (step S12), and the emotion estimation unit 12 acquires the pulse of the customer (step S13).

Next, the emotion estimation unit 12 analyzes the biological data measured by the biological data measurement unit 11, and thereby estimates the emotion of the customer. The handover review unit 14 refers to the action rules stored in the action rule storage unit 17, and determines response content corresponding to the emotion estimated by the emotion estimation unit 12. Furthermore, the handover review unit 14 analyzes the state of the customer from the biological data (step S14). At such time, the information collection unit 13 collects query information from the customer. The reply generation unit 16 acquires the query information from the customer via the handover review unit 14. Furthermore, the reply generation unit 16 generates a reply to the query information from the customer in accordance with the response content determined by the handover review unit 14, and outputs the response as speech using the reply output unit 15, thereby responding to the customer (step S14).

Furthermore, the information collection unit 13 acquires the user ID of the customer. Furthermore, the information collection unit 13 outputs the acquired user ID to the reply generation unit 16 via the handover review unit 14. The reply generation unit 16 transmits the user ID of the customer to the server 20 via the communication unit 18, and requests the history information of the customer (step S15).

Next, the handover analysis unit 22 of the server 20 searches the handover-related information storage unit 23 and extracts the history information of the customer stored in association with the user ID of the customer acquired via the communication unit 21 (step S16).

Next, the communication unit 21 transmits the history information of the customer extracted by the handover analysis unit 22 to the robot 10 (step S17). The reply generation unit 16 acquires the history information of the customer via the communication unit 18. The reply generation unit 16 also uses the history information of the customer to generate reply information for the query information from the customer in accordance with the response content determined by the handover review unit 14, and voices the reply information as speech using the reply output unit 15, thereby responding to the customer.

Processing such as the aforementioned (the processing surrounded by the dot-dash line in the drawing) is repeated, and responses of the robot 10 to the customer are sequentially executed.

Here, in the case where the customer has become dissatisfied and angry with a response of the robot 10 when the robot 10 is providing customer service, the biological data acquired in steps S12 and S13 changes. Here, in the case where the emotion estimation unit 12 has estimated an “anger” emotion of a “high” level, the handover review unit 14 determines that the response to the customer is to be handed over to the customer service successor. Furthermore, the handover review unit 14 notifies response support request information indicating that support from the customer service successor is necessary, and response history information indicating the response content of the robot 10 acquired from the reply generation unit 16, to the server 20 via the communication unit 18 (step S18).

Furthermore, in the case where the customer service provided by the robot 10 has ended without any problems, the handover review unit 14 notifies response history information indicating the response content of the robot 10 acquired from the reply generation unit 16, to the server 20 via the communication unit 18 (step S18).

The handover analysis unit 22, when having acquired the response support request information and the response history information indicating the response content via the communication unit 21, analyzes the response state of the robot 10 with respect to the customer. The handover analysis unit 22 also creates history information of the customer representing the history of the customer service content carried out by the robot 10 including the analysis result, and stores the history information in the handover-related information storage unit 23 (step S19). Furthermore, the handover analysis unit 22 notifies the handover information generation unit 24 that the support of the customer service successor is necessary. The handover information generation unit 24 refers to the history information of the customer in the handover-related information storage unit 23, and generates handover information that includes the response support request information and the response history information (step S19).

Next, the handover information generation unit 24 notifies the handover information including the response support request information and the response history information to the tablet 30 via the communication unit 21 (step S20).

The handover information presentation unit 32 of the tablet 30 acquires the handover information including the response support request information and the response history information via the communication unit 31, and displays an emergency handover screen that is created using the acquired handover information (step S21).

Furthermore, the handover analysis unit 22, when having acquired the response history information indicating the response content via the communication unit 21, analyzes the response state of the robot 10 with respect to the customer. The handover analysis unit 22 also creates history information of the customer representing the history of the customer service content carried out by the robot 10 including the analysis result, and stores the history information of the customer in the handover-related information storage unit 23 (step S19). Furthermore, the handover analysis unit 22 notifies the handover information generation unit 24 that the creation of the history information of the customer has ended. The handover information generation unit 24 refers to the history information of the customer in the handover-related information storage unit 23, and generates handover information including the response history information (step S19).

The handover information generation unit 24 notifies the handover information including the response history information to the tablet 30 via the communication unit 21 (step S20).

The handover information presentation unit 32 of the tablet 30 acquires the handover information including the response history information via the communication unit 31, and displays a normal handover screen that is created using the acquired handover information (step S21).

According to the aforementioned processing, in the present embodiment, the pulse of the customer is acquired, the acquired pulse is analyzed, and the emotion of the customer is thereby estimated. Furthermore, whether or not a response to the customer is to be handed over to the customer service successor is determined on the basis of the estimated emotion.

At such time, in the case where it is determined that the response to the customer is to be handed over to the customer service successor, handover information including the response content carried out by the robot 10 with respect to the customer and handover content that is based on the response content is generated, and the generated handover information is transmitted to the tablet 30 possessed by the customer service successor.

As a result, the customer service successor is able to confirm, on the tablet 30, response content carried out by the robot 10 with respect to the customer and handover content that is based on the response content. Thus, the customer service result of the robot 10 with respect to the customer can be smoothly handed over from the robot 10 to the customer service successor.

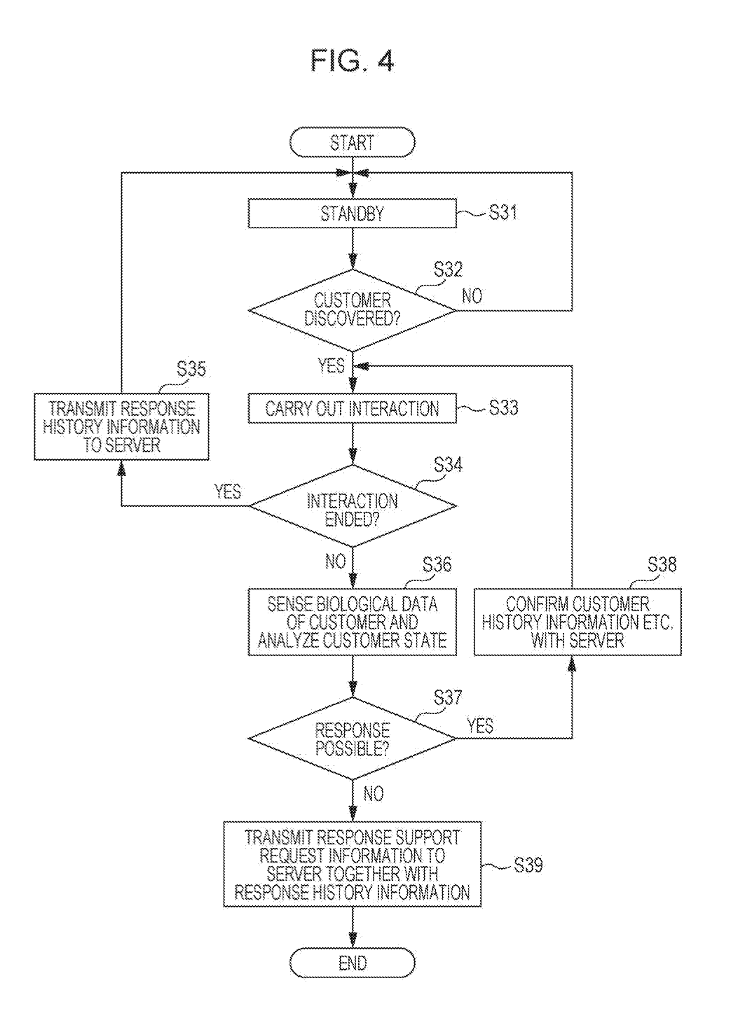

Next, from among the customer service processing performed by the aforementioned customer service system, customer service handover processing performed by the robot 10 will be additionally described in detail. FIG. 4 is a flowchart depicting an example of the customer service handover processing performed by the robot 10 depicted in FIG. 1.

First, the robot 10 is in a standby state (step S31), and is waiting for the visit of a customer at a reception in a hotel, for example.

Next, when a customer has visited the reception, the information collection unit 13 of the robot 10 determines whether or not the customer has been discovered within a captured image (step S32). If the customer is not discovered (no in step S32), the standby processing of step S31 is continued.

However, if the customer is discovered (yes in step S32), the information collection unit 13 acquires speech of the customer and outputs the speech to the handover review unit 14. The handover review unit 14 notifies query information from the customer to the reply generation unit 16. The reply generation unit 16 generates reply information for the query information from the customer. The reply output unit 15 carries out a dialogue with the customer on the basis of the reply information generated by the reply generation unit 16 (step S33).

Next, the handover review unit 14 determines whether or not the dialogue with the customer has ended (step S34). In the case where the dialogue with the customer has ended (yes in step S34), the handover review unit 14 transmits response history information indicating response content of the robot 10 acquired from the reply generation unit 16, to the server 20 using the communication unit 18 (step S35). Thereafter, processing returns to the standby processing of step S31, and the robot 10 waits for the next visit of a customer.

However, if the dialogue with the customer has not yet ended (no in step S34), the biological data measurement unit 11 senses biological data (for example, pulse waves) of the customer. The emotion estimation unit 12 estimates the emotion of the customer from the pulse waves acquired by the biological data measurement unit 11. The handover review unit 14 analyzes the state of the customer on the basis of the emotion of the customer estimated by the emotion estimation unit 12 (step S36).

In addition, the handover review unit 14 determines whether or not it is possible to respond to the customer from the analyzed state of the customer (step S37). For example, in the case where the response content associated with the present emotion of the customer is “issue response support request immediately”, the handover review unit 14 determines that it is not possible to respond to the customer. However, in the case where the response content associated with the present emotion of the customer is some other response content, the handover review unit 14 determines that it is possible to respond to the customer.

If it is determined that it is possible to respond to the customer (yes in step S37), the reply generation unit 16, via the communication unit 18, issues a request to the server 20 for the history information or the like of the customer and acquires the necessary information (step S38). Here, the necessary information is information such as the customer being a premium customer, for example. Then, the processing of step S33 and thereafter is repeated, with the reply generation unit 16 also taking the information acquired from the server 20 into consideration to continue the dialogue with the customer.

However, if it is determined that it is not possible to respond to the customer (no in step S37), the handover review unit 14 transmits response support request information indicating that support from the customer service successor is necessary, and response history information indicating the response content of the robot 10 acquired from the reply generation unit 16, to the server 20 using the communication unit 18, and ends the processing (step S39). Thereafter, the robot 10 waits for the customer service successor to come.

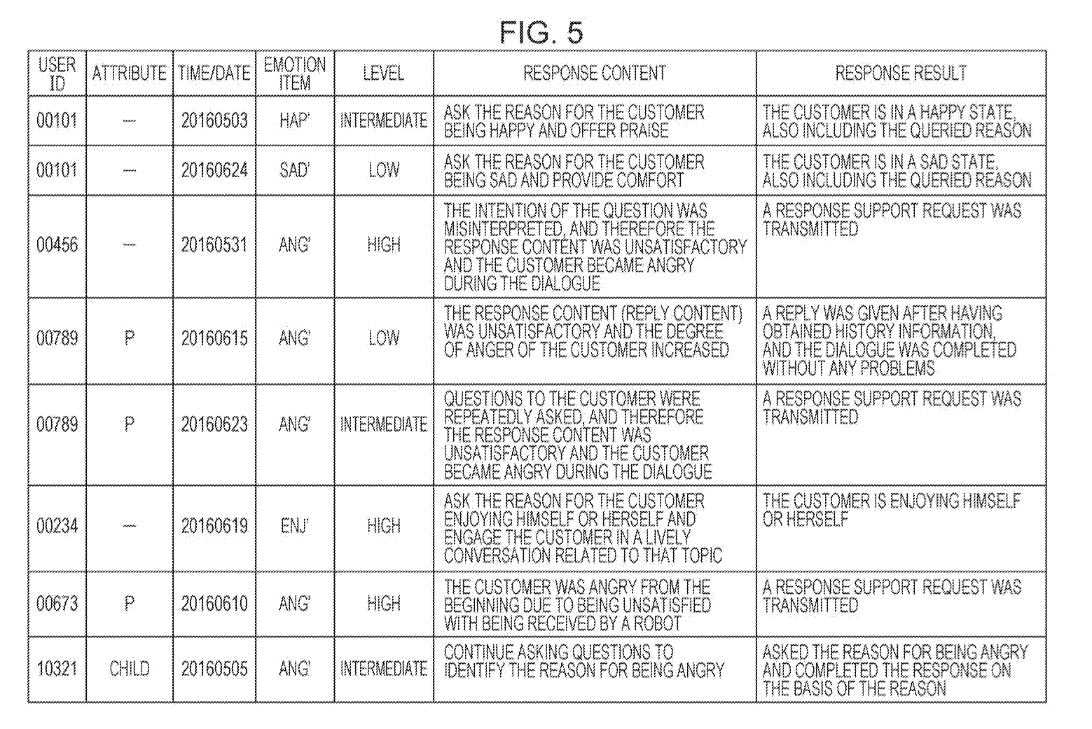

Next, the history information of the customer will be specifically described, which is stored in the handover-related information storage unit 23 of the server 20 due to the customer service handover processing of the robot 10. FIG. 5 is a drawing depicting an example of the history information of the customer stored in the handover-related information storage unit 23 of the server 20 depicted in FIG. 1. It should be noted that, in the description hereinafter, the response content of “issue response support request immediately” is stored in the action rule storage unit 17 in association with the case where the attribute of the customer is not that of a premium customer and “anger” is “high”. Furthermore, the response content of “issue response support request immediately” is stored in the action rule storage unit 17 in association with the case where the attribute of the customer is that of a premium customer and “anger” is “intermediate” or “high”.

As depicted in FIG. 5, the user IDs of customers, the attributes of the customers, the time and date on which customer service has been provided, emotion items indicating the emotions of the customers, the levels of the emotions, response content of the robot with respect to the customers, and the response results of the robot with respect to the customers are stored in the handover-related information storage unit 23 in the form of a table as history information of the customers.

For example, in the case of a customer having the user ID “00101”, the robot 10 provided customer service on May 3rd and Jun. 24, 2016, and “happiness” of an “intermediate” level was estimated as the emotion of the customer on May 3rd. Furthermore, the robot 10 issued the response of “ask the reason for the customer being happy and offer praise”, and a response result of “the customer is in a happy state, also including the queried reason” was stored. “Sadness” of a “low” level was estimated as the emotion of the customer on June 24th. The robot 10 issued the response of “ask the reason for the customer being sad and provide comfort”, and a response result of “the customer is in a sad state, also including the queried reason” was stored.

Furthermore, in the case of a customer having the user ID “00456”, the robot 10 provided customer service on May 31, 2016, and “anger” of a “high” level was estimated as the emotion of the customer. Furthermore, the robot 10 issued the response of “the intention of the question was misinterpreted, and therefore the response content was unsatisfactory and the customer became angry during the dialogue”, and a response result of “a response support request was transmitted” was stored. In this case, the customer was not a premium customer and an “anger” emotion of a “high” level was estimated, and therefore a response support request was transmitted.

Furthermore, in the case of a customer having the user ID “00789”, this customer was a premium customer, and therefore “P” indicating a premium customer was stored as an attribute of the customer. The robot 10 provided customer service on June 15th and Jun. 23, 2016, and “anger” of a “low” level was estimated as the emotion of the customer on June 15th. The robot 10 issued the response of “the response content (reply content) was unsatisfactory and the degree of anger of the customer increased”, and a response result of “a reply was given after having obtained history information, and the dialogue was completed without any problems” was stored. “Anger” of an “intermediate” level was estimated as the emotion of the customer on June 23rd. The robot 10 issued the response of “questions to the customer were repeatedly asked, and therefore the response content was unsatisfactory and the customer became angry during the dialogue”, and a response result of “a response support request was transmitted” was stored. In this case, the customer was a premium customer and an “anger” emotion of a “low” level was estimated on June 15th, and therefore a response support request was not transmitted. However, an “anger” emotion of an “intermediate” level was estimated on June 23rd, and therefore a response support request was transmitted.

Furthermore, in the case of a customer having the user ID “00234”, the robot 10 provided customer service on Jun. 19, 2016, and “enjoyment” of a “high” level was estimated as the emotion of the customer. The robot 10 issued the response of “ask the reason for the customer enjoying himself or herself and engage the customer in a lively conversation related to that topic”, and a response result of “the customer is enjoying himself or herself” was stored.

Furthermore, in the case of a customer having the user ID “00673”, the customer was a premium customer, and therefore “P” indicating a premium customer was stored as an attribute of the customer. The robot 10 provided customer service on Jun. 10, 2016, and “anger” of a “high” level was estimated as the emotion of the customer. The robot 10 issued the response of “the customer was angry from the beginning due to being unsatisfied with being received by a robot”, and a response result of “a response support request was transmitted” was stored. In this case, the customer was a premium customer and an “anger” emotion of a “high” level was estimated, and therefore a response support request was transmitted.

Finally, in the case of a customer having the user ID “10321”, it was detected that this customer was a child, and therefore “child” was stored as an attribute of the customer. The robot 10 provided customer service on May 5, 2016, and “anger” of a “high” level was estimated as the emotion of the customer. The robot 10 issued the response of “continue asking questions to identify the reason for being angry”, and a response result of “asked the reason for being angry and completed the response on the basis of the reason” was stored. This case is an example in which the information collection unit 13 determined whether the customer was an adult or a child, and the result of determining that the customer was a child was stored as an attribute of the customer. In this case, the reply generation unit 16 generated a reply for a child.

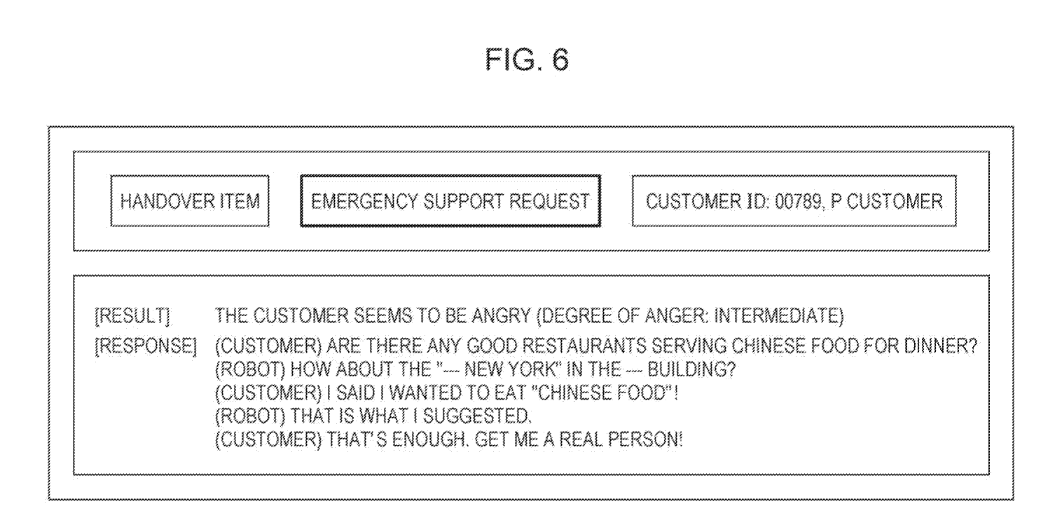

Next, the emergency handover screen will be described, which is displayed on the tablet 30 in the case where a response support request has been transmitted as mentioned above. FIG. 6 is a drawing depicting an example of the emergency handover screen that is displayed on the tablet 30 depicted in FIG. 1. In FIG. 6, handover information including response support request information is displayed.

For example, the emergency handover screen depicted in FIG. 6 is displayed on the tablet 30 for the case where “anger” of an “intermediate” level was estimated in the customer service provided on June 23rd for the customer having the user ID “00789” depicted in FIG. 5. In this example, the robot 10 performs a concierge-like role in a hotel, and a human concierge takes over the customer service as the customer service successor.

First, the text of “emergency support request” is displayed in a large manner in the upper central section of the handover screen. The customer service successor, as a result of seeing this display, is able to know that there is a need for customer service to be urgently handed over. It should be noted that it is desirable for this display to be implemented with an outer border being added in red or the like, in such a way as to be emphasized to a greater degree than other areas.

Furthermore, the text of “customer ID: 00789, P customer” is displayed in the upper-right side of the handover screen. The customer service successor, as a result of seeing this display, is able to know that the customer is a premium customer and that the customer has the user ID “00789”. Consequently, the customer service successor is able to acquire history information or the like of the customer having the user ID of “00789” from the server 20 using the tablet 30, and to be of use for the present customer service.

Furthermore, “result” indicating the response result and “response” indicating the response content provided by the robot 10 to the customer are displayed in the lower half of the handover screen, and the customer service successor refers to the conversation between the robot 10 and the customer indicated in “response”, and is thereby able to know the response result of “the customer seems to be angry” with “degree of anger: intermediate” (“anger” of an “intermediate” level). Consequently, the customer service successor is able to provide appropriate customer service on the basis of the specific dialogue content and the estimated emotion of the customer.

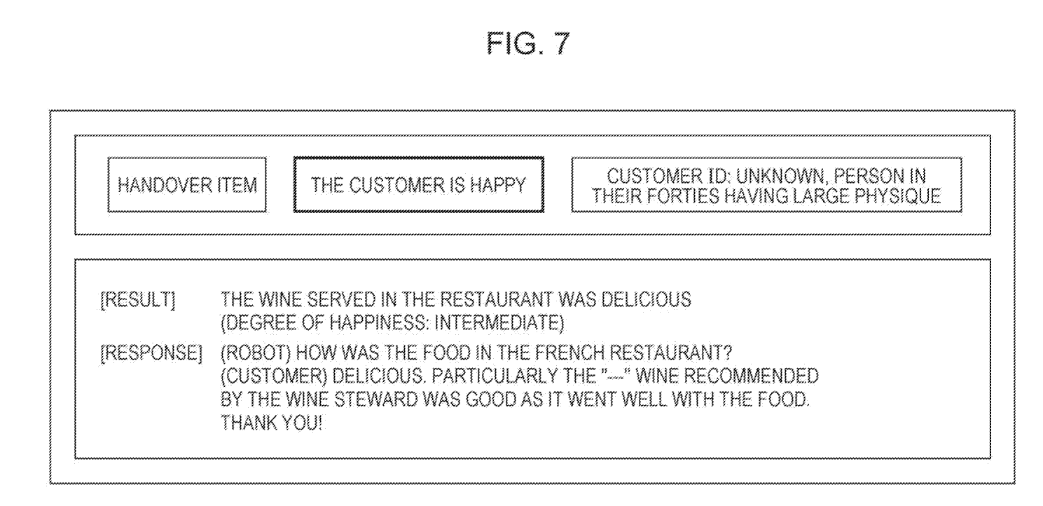

Next, the normal handover screen will be described. The normal handover screen is displayed on the tablet 30 in the case where a response support request is not transmitted and the handover information is transmitted. FIG. 7 is a drawing depicting an example of the normal handover screen that is displayed on the tablet 30 depicted in FIG. 1. In FIG. 7, handover information not including response support request information is displayed.

In the example depicted in FIG. 7, the robot 10, which happened to be passing by, has spoken to a customer, for whom a user ID is not able to be acquired, at the exit of a restaurant in the hotel, for example.

First, text of “the customer is happy” is displayed in the upper central section of the handover screen, and the customer service successor, as a result of seeing this display, is able to know that the robot 10 has been able to provide appropriate customer service to the customer.

The text of “customer ID: unknown, person in their forties having large physique” is displayed in the upper-right side of the handover screen. Since the user ID is unknown, the customer service successor is not able to specify the customer. However, since a feature (person in their forties having large physique) of the customer is displayed as an attribute of the customer, the present handover information can be used for customer service in the future in the case where the customer can be specified from this feature. It should be noted that the aforementioned feature of the customer was collected by the information collection unit 13 as an attribute of the customer.

Furthermore, “result” and “response” are displayed in the lower half of the handover screen, and the customer service successor is able to know the response result of “the wine served in the restaurant was delicious” with “degree of happiness: intermediate” (“happiness” of an “intermediate” level), from the conversation between the robot 10 and the customer indicated in “response”. Consequently, the customer service successor is able to use the specific dialogue content and the estimated emotion of the customer for customer service in the future.

Hereinabove, a customer service system according to an aspect of the present disclosure has been described on the basis of the aforementioned embodiments; however, the present disclosure is not limited to the aforementioned embodiments. Modes in which various modifications conceived by a person skilled in the art have been implemented in the present embodiments, and modes constructed by combining the constituent elements in different embodiments may also be included within the scope of the present disclosure provided they do not depart from the purpose of the present disclosure.

The customer service device, customer service method, and customer service system according to the present disclosure enable a customer service result of the customer service device with respect to a customer to be smoothly handed over from the customer service device to a customer service successor, and are therefore useful as a customer service device, customer service method, and customer service system with which customer service is provided to a customer and a customer service result is handed over to a customer service successor.

What is claimed is:

1. A customer service device, comprising:
an estimator that estimates an emotion of a customer by analyzing biological data of the customer;
a handover reviewer that determines whether or not a response to the customer is to be handed over to a customer service successor, based on the emotion estimated by the estimator;
a handover information generator that, when the handover reviewer has determined that the response to the customer is to be handed over to the customer service successor, generates handover information including first response content carried out to the customer and handover content that is based on the first response content; and
a communicator that transmits the handover information generated by the handover information generator.

2. The customer service device according to claim 1, further comprising: a biological data detector that acquires the biological data of the customer.

3. The customer service device according to claim 1, wherein when the handover reviewer has determined that the response to the customer is to be handed over to the customer service successor, the handover information generator generates the handover information including response support request information indicating that support by the customer service successor is necessary.

4. The customer service device according to claim 1, further comprising:
a first storage that stores, in advance, second response content to be carried out to the customer, in association with the emotion of the customer, wherein
the handover reviewer refers to the first storage and, when the second response content associated with the emotion estimated by the estimator is a response support request for the customer service successor, determines that the response to the customer is to be handed over to the customer service successor.

5. The customer service device according to claim 4, wherein
the estimator estimates a plurality of levels indicating degree of anger of the customer by analyzing the biological data,
the first storage stores, in advance, the second response content to be carried out to the customer, in association with each of the plurality of levels, and
the handover reviewer refers to the first storage and, when a level estimated by the estimator is equal to or greater than a predetermined level, determines that the response to the customer is to be handed over to the customer service successor.

6. The customer service device according to claim 5, further comprising:
an attribute acquirer that acquires an attribute of the customer, wherein
the handover reviewer,
when the attribute of the customer acquired by the attribute acquirer does not correspond to a predetermined important condition and an anger emotion estimated by the estimator is equal to or greater than a first level, determines that the response to the customer is to be handed over to the customer service successor, and
when the attribute of the customer acquired by the attribute acquirer corresponds to the predetermined important condition and the anger emotion estimated by the estimator is equal to or greater than a second level that is lower than the first level, determines that the response to the customer is to be handed over to the customer service successor.

7. The customer service device according to claim 1, further comprising:
an identification information acquirer that acquires identification information identifying the customer;
a second storage that stores history information indicating past customer service history for the customer, in association with the identification information; and
a response determiner that acquires the history information of the customer corresponding to the identification information acquired by the identification information acquirer from the second storage, and determines the response to the customer, based on the history information.

8. The customer service device according to claim 7, wherein
when the handover reviewer has determined that the response to the customer is not to be handed over to the customer service successor, the handover information generator generates the handover information including the first response content carried out to the customer and the handover content that is based on the first response content, and
the second storage stores the handover information generated by the handover information generator, as the history information.

9. The customer service device according to claim 1, wherein the handover information generator generates the handover information including emotion information indicating the emotion estimated by the estimator.

10. The customer service device according to claim 1, further comprising a reply outputter that includes at least one of a speaker, a display, and a human-shaped body, and provides customer service to the customer by using at least one of speech, video, and movement.

11. A customer service method, including:
acquiring biological data of a customer;
estimating an emotion of the customer by analyzing the biological data;
determining whether or not a response to the customer is to be handed over to a customer service successor, based on the emotion;
when it is determined that the response to the customer is to be handed over to the customer service successor, generating handover information including response content carried out to the customer and handover content that is based on the response content; and
transmitting the handover information.

12. A customer service system, comprising:
a robot that provides customer service to a customer;
a server that communicates with the robot; and
a communication terminal that communicates with the server, wherein
the robot comprises:
an estimator that estimates an emotion of the customer by analyzing biological data of the customer; and
a handover reviewer that determines whether or not a response to the customer is to be handed over to a customer service successor, based on the emotion estimated by the estimator,
the server comprises:
a handover information generator that, when the handover reviewer has determined that the response to the customer is to be handed over to the customer service successor, generates handover information including response content carried out to the customer and handover content that is based on the response content; and
a communicator that transmits the handover information generated by the handover information generator to the communication terminal, and
the communication terminal comprises a handover information presenter that presents the handover information.

13. The customer service system according to claim 12, wherein the robot further comprises a biological data detector that acquires the biological data of the customer.
